(19) United States
(12) Patent Application Publication
(10) Pub. No.: US 2024/0092616 A1
(43) Pub. Date: Mar. 21, 2024

(54) HITCH MOUNT FOR HOIST

(71) Applicant: Hubbell Incorporated, Shelton, CT (US)

(72) Inventors: Brian David MOEGLING, Columbia, MO (US); Lawrence Gerard BERESWILL, Columbia, MO (US)

(21) Appl. No.: 18/369,914

(22) Filed: Sep. 19, 2023

Related U.S. Application Data
(60) Provisional application No. 63/407,777, filed on Sep. 19, 2022.

(51) Int. Cl. B66D 1/74; B66C 23/44

(52) U.S. Cl. CPC B66D 1/7463; B66C 23/44; B66D 1/7415; B66D 2700/025; B66D 2700/026

(57) ABSTRACT

A hitch mount for a hoist including a main member having a proximal end and a distal end, the proximal end configured to couple with a vehicle hitch, a hoist mounting bracket at the distal end of the main member, a pulley mounted on the main member between the proximal end and the distal end, and a rope lock mounted on the main member between the pulley and the distal end.

### FIELD OF THE INVENTION

The present disclosure relates to capstan hoists used in the telecom and utility field, and more particularly, to a vehicle hitch mount for a capstan hoist.

### BACKGROUND

A capstan hoist is a motorized device, used for lifting and pulling operations, that multiplies the force imparted by a user on a rope that is wrapped around a capstan drum. Capstan hoists are commonly used in the telecom and utility field to set up utility poles, erect cell towers, install antennas and other cell tower equipment, pull wheeled equipment over obstacles, raise transformers, hoist heavy insulators, string and tension conductors, pull indoor and underground cable.

Capstan hoists often need to be mounted to vehicles during operation due to worksite conditions and regulations. Hitch mounts have been used for years to mount capstan hoists to tow hitches on the back of vehicles. However, existing hitch mounts allow extensive cantilever forces at the capstan hoist that may exceed the design of hitch receivers and sometimes result in the vehicle being picked up or moved unintentionally.

Additionally, most existing mounts have no way of restricting the angle that a rope can contact the capstan drum (fleet angle), which can lead to the rope overwrapping the drum and binding up, which creates a difficult, time consuming, and potentially dangerous circumstance. Further, when capstan hoists are placed on the worksite, the operator must often stand in a particular location to operate the capstan hoist. This puts the operator in an awkward position between the hoist and their truck's tailgate with little room to move.

There is a need for improved hitch mounts for capstan hoists. The present invention solves these and other problems in the prior art.

### SUMMARY

An object of the present invention is to provide an improved hitch mount for capstan hoists that reduces cantilever forces on the mount and improves the ease and safety of operation.

In one exemplary embodiment according to the present disclosure, a hitch mount for a hoist is provided, including a main member having a proximal end and a distal end, the proximal end configured to couple with a vehicle hitch, a hoist mounting bracket at the distal end of the main member, a pulley mounted on the main member between the proximal end and the distal end, and a rope lock mounted on the main member between the pulley and the distal end. The main member may be, for example, a rectangular beam. In some embodiments, the hoist mounting bracket is configured to retain the hoist in a vertical orientation.

In some embodiments, the pulley includes a pulley wheel rotatably mounted in a pulley housing, wherein the pulley housing is rotatable about an axis. The axis about which the pulley housing rotates may be parallel or approximately parallel to the main member. The pulley may further include a bracket for attaching the pulley housing to the main member and/or an eyelet on the bracket. The pulley housing may also have a gate configured to open and close the pulley housing.

In some embodiments, the rope lock includes a drum and a rotatable cam defining a space for receiving a rope therebetween. The cam may include at least one spring biasing the cam to a closed position. In some embodiments, the rope lock further includes a mechanism on the cam configured to selectively rotate the cam to an open position. The mechanism may include an attachment mechanism on a side of the cam for receiving a pulling force from a user.

In other embodiments, the rope lock includes a rope lock cam pivotable about an axis and a housing having an upper portion extending at least partially over the rope lock cam, wherein the rope lock is configured to selectively retain a rope between the rope lock cam and the upper portion of the housing. The rope lock cam may include a surface facing the upper portion of the housing having a plurality of protrusions. The rope lock cam may be biased in a locked position by a spring.

In some embodiments, the hoist mounting bracket includes a base plate shaped to at least partially circumscribe a capstan hoist. The hoist mounting bracket may include an interface for removably attaching the hoist mounting bracket to the distal end of the main member.

Further provided is a hoist assembly including a main member having a proximal end and a distal end, the proximal end configured to couple with a vehicle hitch, a hoist mounting bracket at the distal end of the main member, a hoist attached to the hoist mounting bracket including a motor and a drum operable by the motor, a pulley mounted on the main member between the proximal end and the distal end, and the rope lock mounted on the main member between the pulley and the distal end.

In some embodiments, the rope lock includes a rope lock cam pivotable about an axis and a housing having an upper portion extending at least partially over the rope lock cam, wherein the rope lock is configured to selectively retain a rope between the rope lock cam and the upper portion of the housing. The rope lock cam may include a surface facing the upper portion of the housing having a plurality of protrusions. The rope lock cam may be biased in a locked position by a spring.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is an isometric view of hitch mount according to an exemplary embodiment of the present disclosure;

FIG. 2 is top view of the hitch mount shown in FIG. 1;

FIG. 3 is a side view of the hitch mount shown in FIG. 1;

FIG. 4 is an isometric view of a hoist mounting bracket of the hitch mount shown in FIG. 1;

FIG. 5 is an isometric view of a pulley assembly of the hitch mount shown in FIG. 1;

FIG. 6 is another isometric view of the pulley assembly shown in FIG. 5;

FIG. 7 is an isometric view of the pulley assembly shown in FIG. 5 in an open configuration;

FIG. 8 is an isometric view of a rope lock of the hitch mount shown in FIG. 1;

FIG. 9 is another isometric view of the rope lock shown in FIG. 8;

FIG. 10 is an isometric view of the rope lock shown in FIG. 8 with a latch member in an open configuration;

FIG. 11 is a partially disassembled isometric view of the rope lock shown in FIG. 8;

FIG. 12 is another partially disassembled isometric view of the rope lock shown in FIG. 8;

FIGS. 13A and 13B are isometric views of hitch mount according to an exemplary embodiment of the present disclosure;

FIG. 14 is an isometric view of a rope lock of the hitch mount shown in FIGS. 13A and 13B;

FIG. 15 is a side view of the rope lock shown in FIG. 14; and

FIG. 16 is a rear view of the rope lock shown in FIG. 14.

### DETAILED DESCRIPTION

The present disclosure may be understood more readily by reference to the following detailed description of the disclosure taken in connection with the accompanying drawing figures, which form a part of this disclosure. It is to be understood that this disclosure is not limited to the specific devices, methods, conditions, or parameters described and/or shown herein, and that the terminology used herein is for the purpose of describing particular embodiments by way of example only and is not intended to be limiting of the claimed disclosure.

Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, horizontal, vertical, top, upper, lower, bottom, left and right, are for illustrative purposes only and can be varied within the scope of the disclosure.

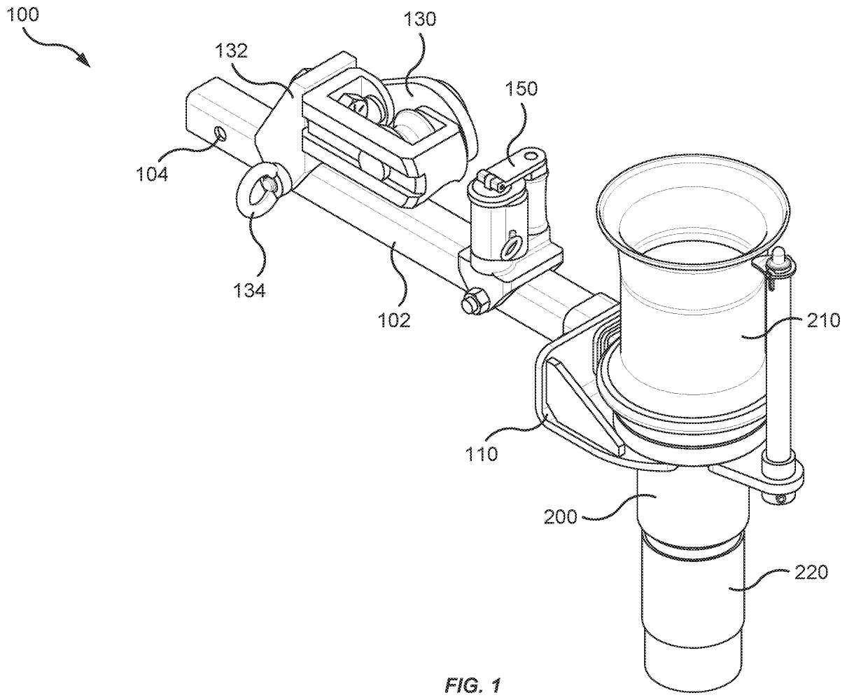

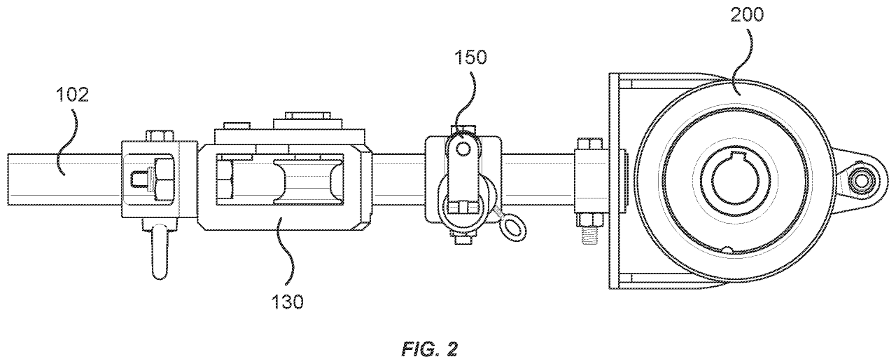

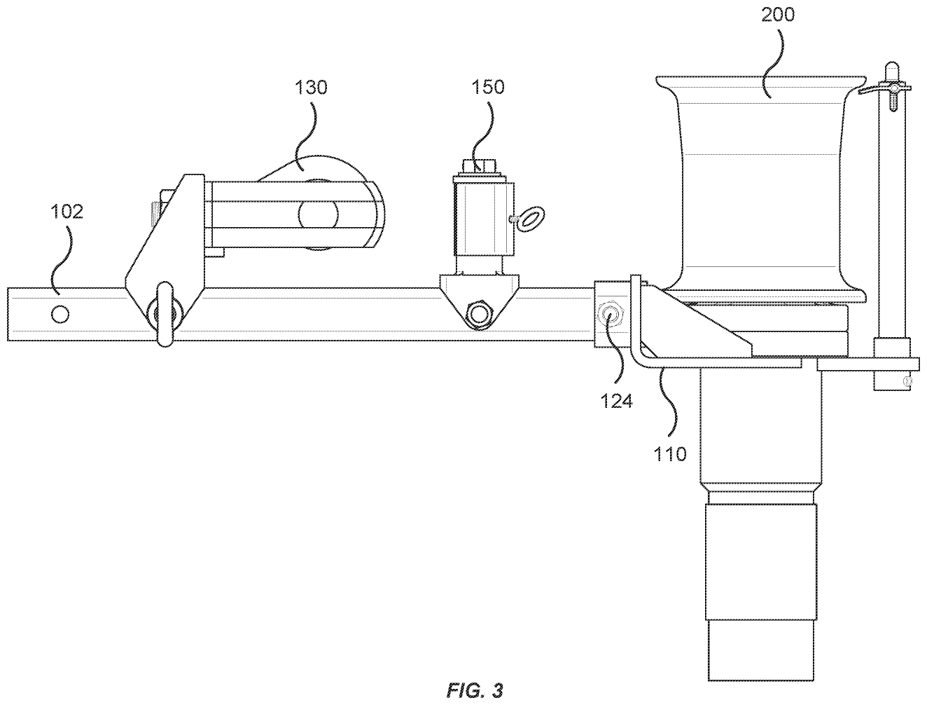

FIGS. 1-3 show a hitch mount 100 according to an exemplary embodiment of the present disclosure. The hitch mount 100 includes main member 102 which, in the exemplary embodiment, is in the form of a beam having a rectangular (e.g., square) cross-section. In the exemplary embodiment, the main member 102 is approximately 24 in. in length, though different lengths may be used for different applications. The main member 102 has a proximal end which is configured to engage with or in a tow hitch on a vehicle. For example, the proximal end of the main member 102 may be sized and shaped to engage into a standard 2 in. square hitch receiver. The proximal end of the main member 102 may have one or more holes 104 for receiving a hitch pin.

A distal end of the main member 102 has a hoist mounting bracket 110 for receiving a hoist, such as capstan hoist 200. The hoist mounting bracket 110 may be formed integrally with the main member 102 or, as shown in the exemplary embodiment, may be removably attached to the distal end of the main member 102. The hitch mount 100 may accommodate various commercially available capstan hoists, such as those available from the applicant. As one skilled in the art would understand, the capstan hoist 200 includes a drum 210 and a motor assembly 220 for driving the drum 210.

Unlike prior art devices, the capstan hoist 200 is mounted vertically in the hoist mounting bracket 110. The vertical orientation improves the versatility of the capstan hoist 200 and does not limit where the operator must stand in relation to the capstan hoist 200 during operation, thereby improving safety.

The hitch mount 100 further includes a pulley assembly 130 mounted to the main member 102 between the proximal and distal ends of the main member 102. The pulley assembly 130 has a bracket 132 and is configured to swivel on the bracket 132 about an axis. In the exemplary embodiment, the axis is parallel or approximately parallel to the main member 102. In some embodiments, the pulley assembly 130 and/or bracket 132 includes an eyelet 134 (e.g., an eye nut or eye bolt) which is explained further below.

A rope lock 150 is mounted to the main member 102 between the pulley assembly 130 and the distal end of the main member 102. In operation, a rope is fed through the pulley assembly 130, fed through the rope lock 150, and wound around the drum 210 of the capstan hoist 200. The rope lock 150 prevents the rope from slipping and/or a load on the end of the rope from being dropped.

In operation, a user, standing in any position around the capstan hoist 200, pulls on the rope that is wound around the drum 210 to conduct a hoisting or pulling operation. If the rope slips from the user's hand, the rope lock 150 prevents the rope from inadvertently reversing direction. The load force is redirected close to the proximal end of the main member 102 by means of the pulley assembly 130. This reduces cantilever forces on the hitch mount 100 due to the load line contact point being closer to the hitch receiver of the vehicle. Further, unlike prior art devices, the rope or line enters the drum 210 from a fixed position (i.e., from the rope lock 150), eliminating the possibility of an improper fleet angle. This limits the chances of the rope overwrapping the drum and binding up.

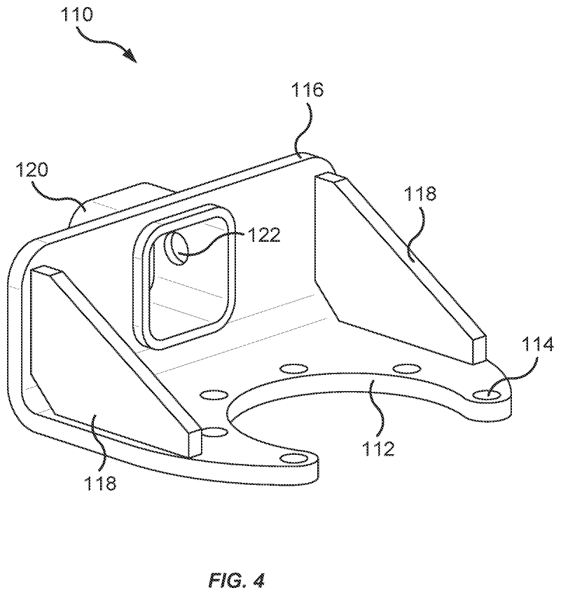

FIG. 4 further illustrates the hoist mounting bracket 110. The hoist mounting bracket 110 includes a base plate 112 shaped to at least partially circumscribe the capstan hoist 200. The base plate 112 has a plurality of holes 114 for receiving fasteners to engage with corresponding holes in a housing of the capstan hoist 200. A vertical plate 116 is attached to or formed integrally with the base plate 112 with side supports 118 therebetween. The hoist mounting bracket 110 may further include an interface 120 for attaching to the distal end of the main member 102. In the exemplary embodiment, the interface 120 is a square receiver for receiving the distal end of the main member 102. The interface 120 may further include holes 122 for receiving a fastener 124.

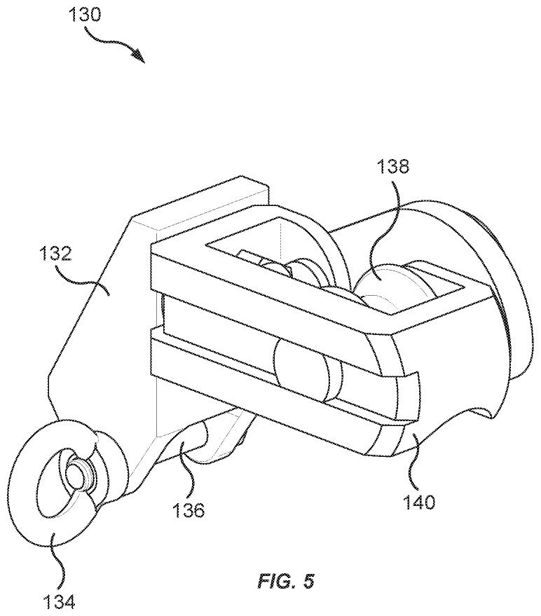

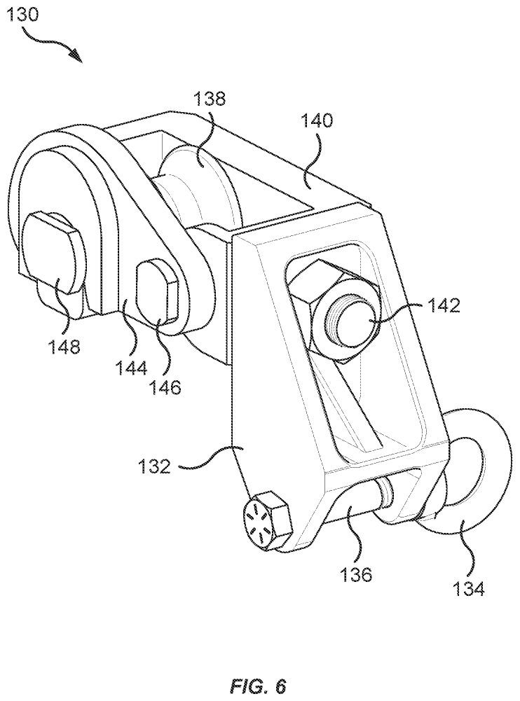

FIGS. 5-6 further illustrate the pulley assembly 130. In the exemplary embodiment, the bracket 132 of the pulley assembly 130 is configured to engage over the main member 102 and attach with a fastener 136 (e.g., bolt). In the exemplary embodiment, the eyelet 134 is an eye nut threaded on an end of the fastener 136. The pulley assembly 130 further includes a pulley wheel 138 rotatably secured in a housing 140. The housing 140 is secured to the bracket 132 with a fastener 142. In some embodiments, the housing 140 is rotatable about an axis defined by the fastener 142. The housing 140 may be rotatable 360 degrees about the axis or rotation may be limited (e.g., 180 degrees or less).

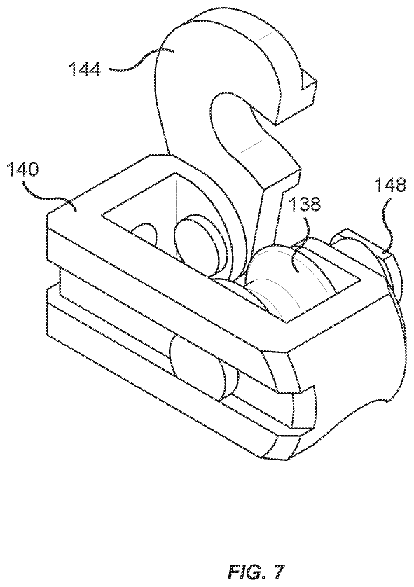

As shown in FIG. 7, the pulley assembly 130 is configured to open to allow for a rope to be fed along the pulley wheel 138. In the exemplary embodiment, the pulley assembly 130 has a gate 144 that is rotatable about a hinge or hinge pin 146 between an open position and a closed position. In the closed position, the gate 144 is secured against or around a stop 148.

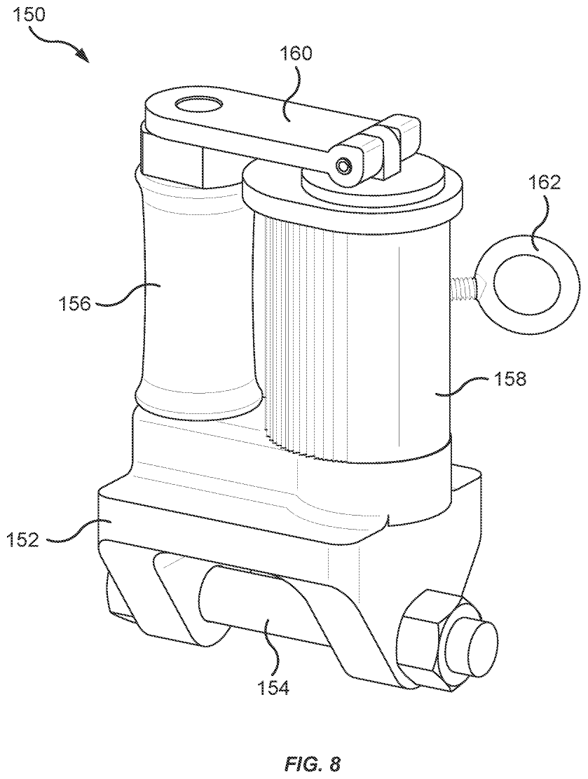

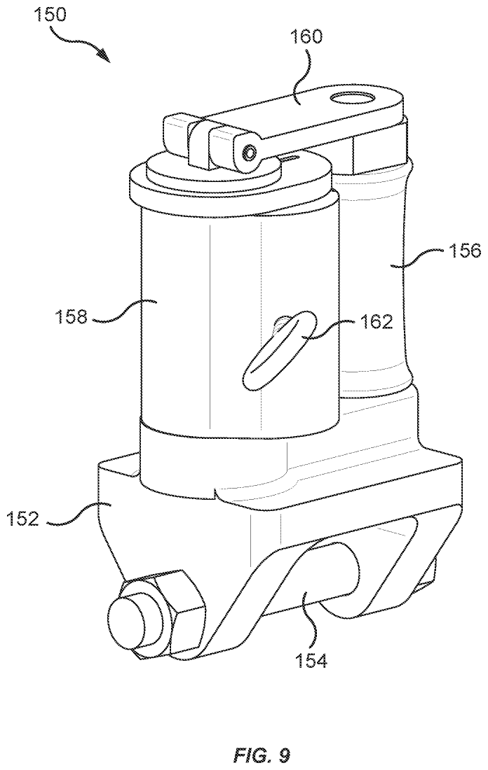

FIGS. 8-9 further illustrate the rope lock 150. The rope lock 150 includes a housing 152 configured to attach to and/or around the main member 102 with a fastener 154. The rope lock 150 further includes a drum 156 and a cam 158 defining a space or gap for receiving a rope therebetween. The drum 156 may freely rotate about an axis (vertical axis) or may be fixed. In the exemplary embodiment, the cam 158 has asymmetric cross-section (about its axis of rotation) such that rotation of the cam 158 opens or at least partially closes the space between the drum 156 and cam 158. The cam 158 may, for example, be biased to a closed position to prevent a rope fed through the rope lock 150 from slipping if the user loses a grip on the rope.

The rope lock 150 is configured to allow a user to open the rope lock 150, and temporarily disable it from catching the rope, when desired. In some embodiments, the cam 158 of the rope lock 150 includes an attachment mechanism 162 (e.g., eyelet). The attachment mechanism 162 is positioned such that a pulling force on the attachment mechanism 162 by a user will rotate the cam 158 and open the space between the drum 156 and the cam 158. For example, a release rope can be attached to the attachment mechanism 162 and fed through the eyelet 134. Pulling of the release rope by a user will then rotate the cam 158 and open the rope lock 150. Other means may be implemented to open and close the rope lock 150.

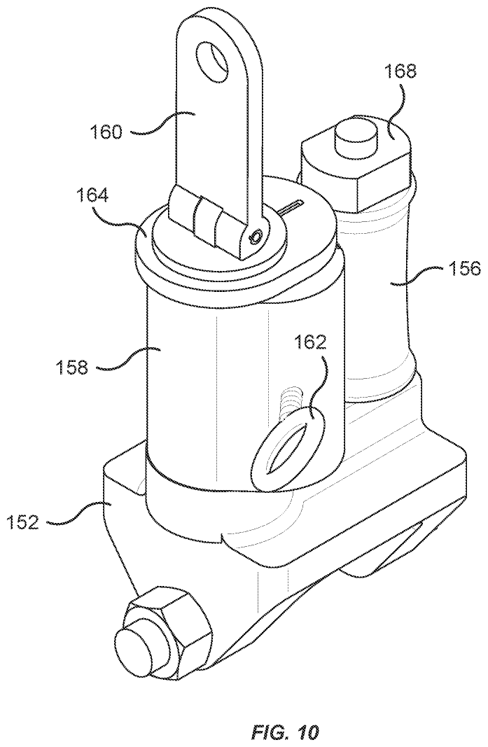

A latch 160 is provided on the top of the rope lock 150 to provide access to the space between the drum 156 and the cam 158 to feed a rope therethrough. FIG. 10 shows the latch 160 and rope lock 150 in an open configuration. In the exemplary embodiment, the latch 160 is hingedly attached to the rope lock 150 above the cam 158. A latch receiver 168 is positioned above the drum 156 for receiving a distal end of the latch 160 when it is closed.

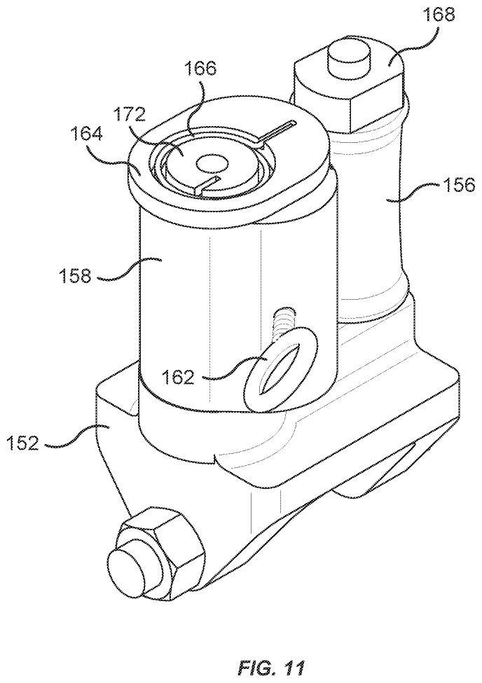

FIG. 11 is a partially disassembled view of the rope lock 150 with the latch 160 removed. In the exemplary embodiment, the rope lock 150 includes a spring housing 164 positioned above the cam 158. The spring housing 164 surrounds a rod 172 of the housing 152. The spring housing 164 includes a recess with a spring 166 therein to bias the cam 158 in a rotational direction. Ends of the spring 166 are engaged in corresponding slots on the rod 172 and spring housing 164.

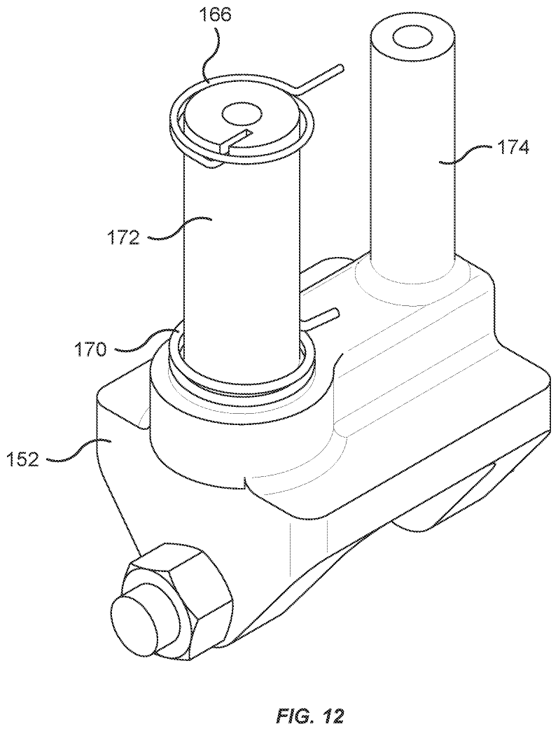

FIG. 12 is another partially disassembled view of the rope lock 150. The housing 152 includes a first rod 172 and a second rod 174 for receiving the cam 158 and drum 156, respectively. The first rod 172 and the second rod 174 may be formed integrally with the housing 152 (as shown) or may be removably attached thereto. In the exemplary embodiment, the first rod 172 has a diameter than is greater than a diameter of the second rod 174. A second spring 170 may be positioned on the bottom of the first rod 172.

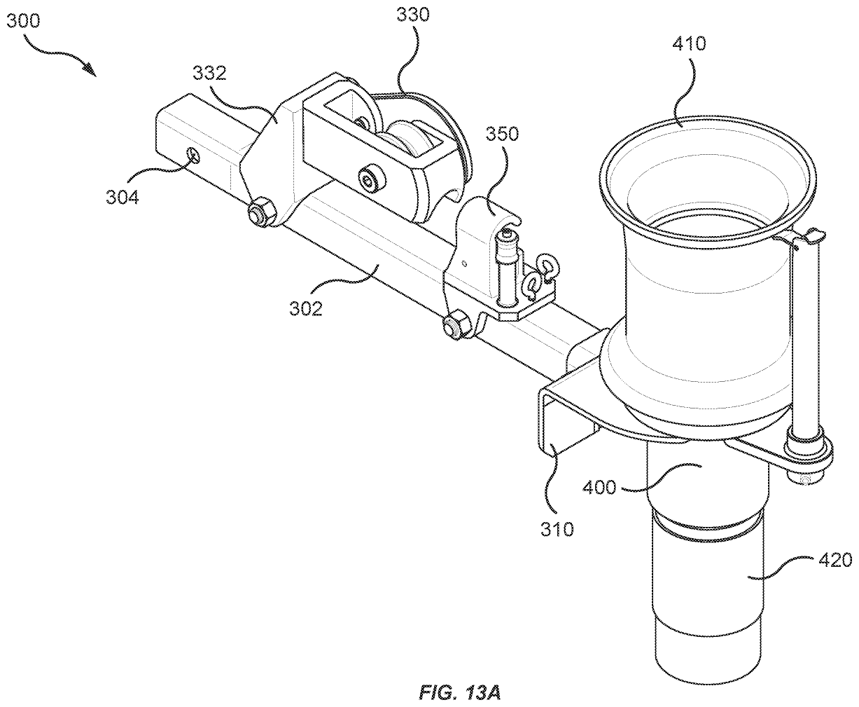

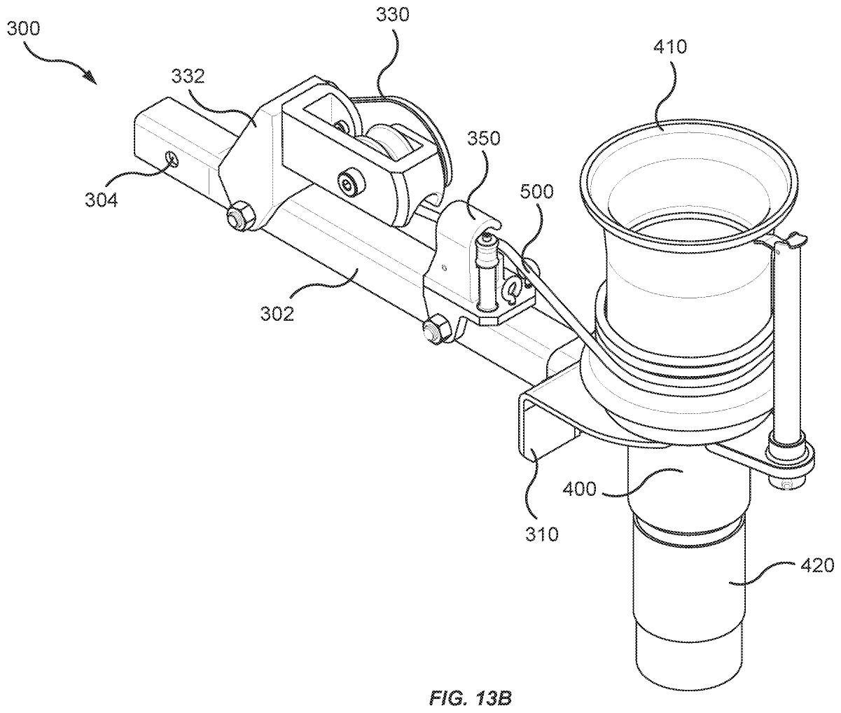

FIGS. 13A-13B show a hitch mount 300 according to an exemplary embodiment of the present disclosure. The hitch mount 300 operates in a similar manner to the hitch mount 300 and may share the components thereof. The hitch mount 300 includes main member 302 having a proximal end which is configured to engage with or in a tow hitch on a vehicle. As with the hitch mount 100, the proximal end of the main member 302 may be sized and shaped to engage into a standard 2 in. square hitch receiver. The proximal end of the main member 302 may have one or more holes 304 for receiving a hitch pin.

A distal end of the main member 302 has a hoist mounting bracket 310 for receiving a hoist, such as capstan hoist 400. The hoist mounting bracket 310 may be formed integrally with the main member 302 or, as shown in the exemplary embodiment, may be removably attached to the distal end of the main member 302. The capstan hoist 400 includes a drum 410 and a motor assembly 420 for driving the drum 410.

The hitch mount 300 further includes a pulley assembly 330 mounted to the main member 302 between the proximal and distal ends of the main member 302. The pulley assembly 330 has a bracket 332 and is configured to swivel on the bracket 332 about an axis. A rope lock 350 is mounted to the main member 302 between the pulley assembly 330 and the distal end of the main member 302. Though not shown, the pulley assembly 330 may include one or more eyelets as in the hitch mount 100.

As shown in FIG. 13B, a rope 500 may be fed through the pulley assembly 330, fed through the rope lock 350, and wound around the drum 410 of the capstan hoist 400. The rope lock 350 prevents the rope 500 from slipping and/or a load on the end of the rope from being dropped.

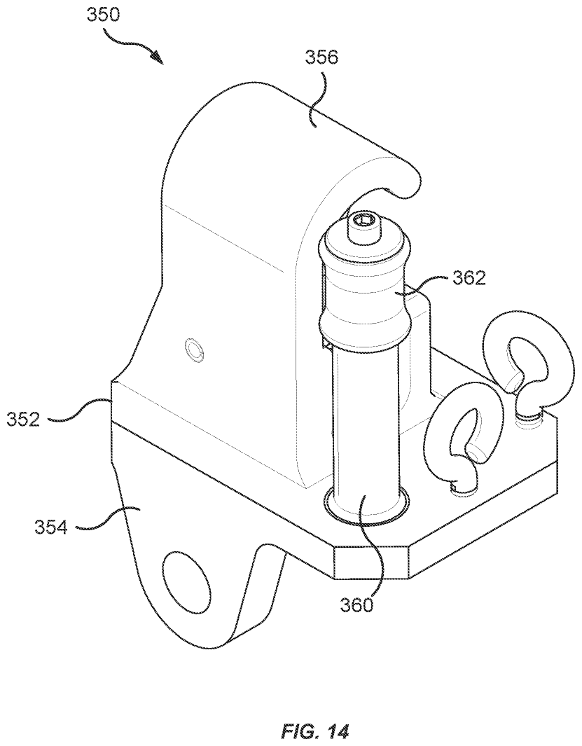

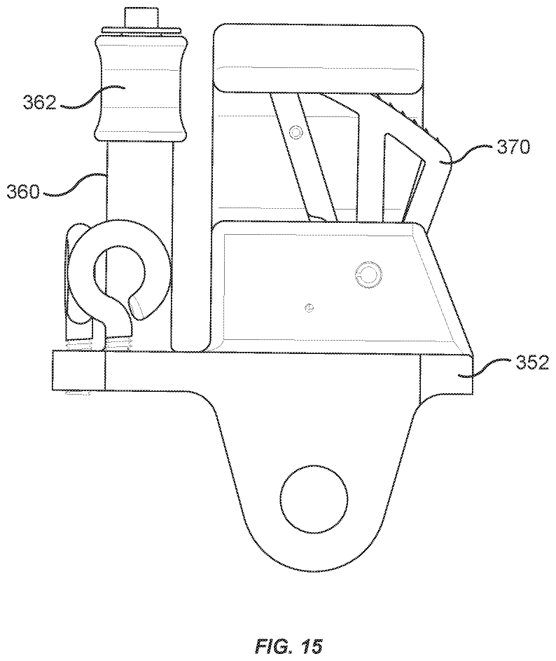

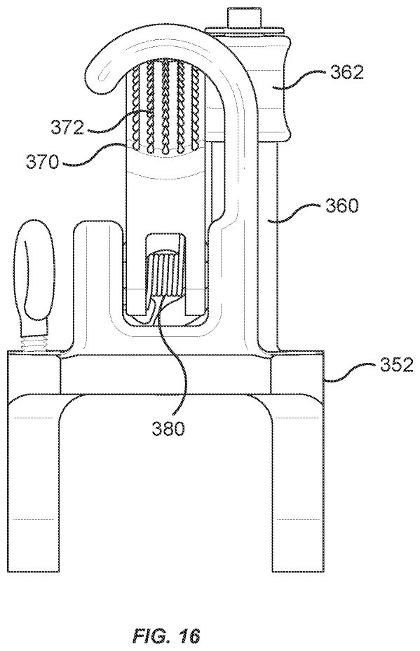

FIGS. 14-16 further illustrate the rope lock 350. The rope lock 350 includes a housing 352 configured to attach to and/or around the main member 302 with a fastener. The housing 352 including a lower portion 354, configured to attach over or to the main member 302, and a curved upper portion 356. The rope lock 350 further includes a roller shaft 360 having a roller 362 at its distal end. A rope lock cam 370 having an outer surface with a plurality of protrusions 372 is positioned under the curved upper portion 356 of the housing 352. The rope lock cam 370 is rotatable about an axis and bias in a locked position by a spring 380. In the locked position, the rope lock cam 370 is at least partially against or adjacent to the curved upper portion 356 to lock the rope 500 in the rope lock 350.

As shown throughout the drawings, like reference numerals designate like or corresponding parts. While illustrative embodiments of the present disclosure have been described and illustrated above, it should be understood that these are exemplary of the disclosure and are not to be considered as limiting. Additions, deletions, substitutions, and other modifications can be made without departing from the spirit or scope of the present disclosure. Accordingly, the present disclosure is not to be considered as limited by the foregoing description.

What is claimed is:

1. A hitch mount for a hoist, comprising:
a main member having a proximal end and a distal end, the proximal end configured to couple with a vehicle hitch;
a hoist mounting bracket at the distal end of the main member;
a pulley mounted on the main member between the proximal end and the distal end; and
a rope lock mounted on the main member between the pulley and the distal end.

2. The hitch mount of claim 1, wherein the main member is a rectangular beam.

3. The hitch mount of claim 1, wherein the hoist mounting bracket is configured to retain the hoist in a vertical orientation.

4. The hitch mount of claim 1, wherein the pulley includes a pulley wheel rotatably mounted in a pulley housing, wherein the pulley housing is rotatable about an axis.

5. The hitch mount of claim 4, wherein the axis is parallel to the main member.

6. The hitch mount of claim 4, wherein the pulley includes a bracket for attaching the pulley housing to the main member.

7. The hitch mount of claim 4, wherein the pulley housing includes a gate configured to open and close the pulley housing.

8. The hitch mount of claim 1, wherein the rope lock includes a drum and a rotatable cam defining a space for receiving a rope therebetween, at least one spring biasing the cam to a closed position, and a latch for accessing the space between the drum and the cam.

9. The hitch mount of claim 8, wherein the rope lock further includes a mechanism on the cam configured to selectively rotate the cam to an open position, the mechanism including an attachment device on a side of the cam for receiving a pulling force from a user.

10. The hitch mount of claim 1, wherein the rope lock includes a rope lock cam pivotable about an axis and a housing having an upper portion extending at least partially over the rope lock cam, wherein the rope lock is configured to selectively retain a rope between the rope lock cam and the upper portion of the housing.

11. The hitch mount of claim 10, wherein the rope lock cam includes a surface facing the upper portion of the housing having a plurality of protrusions.

12. The hitch mount of claim 10, wherein the rope lock cam is biased in a locked position by a spring.

13. The hitch mount of claim 10, wherein the rope lock further includes a roller shaft having a roller at a distal end of the roller shaft.

14. The hitch mount of claim 1, wherein the hoist mounting bracket includes a base plate shaped to at least partially circumscribe a capstan hoist.

15. A hoist assembly, comprising:
a main member having a proximal end and a distal end, the proximal end configured to couple with a vehicle hitch;
a hoist mounting bracket at the distal end of the main member;
a hoist attached to the hoist mounting bracket including a motor and a drum operable by the motor;
a pulley mounted on the main member between the proximal end and the distal end; and
a rope lock mounted on the main member between the pulley and the distal end.

16. The hoist assembly of claim 15, wherein the hoist mounting bracket is attached to the hoist mounting bracket in a vertical orientation.

17. The hoist assembly of claim 15, wherein the main member is a rectangular beam.

18. The hoist assembly of claim 15, wherein the pulley includes a pulley wheel rotatably mounted in a pulley housing, wherein the pulley housing is rotatable about an axis parallel to the main member.

19. The hoist assembly of claim 15, wherein the rope lock includes a rope lock cam pivotable about an axis and a housing having an upper portion extending at least partially over the rope lock cam, wherein the rope lock is configured to selectively retain a rope between the rope lock cam and the upper portion of the housing.

20. The hoist assembly of claim 19, wherein the rope lock cam includes a surface facing the upper portion of the housing having a plurality of protrusions, and wherein the rope lock cam is biased in a locked position by a spring.
